(19) United States
(12) Patent Application Publication
(10) Pub. No.: US 2019/0314835 A1
(43) Pub. Date: Oct. 17, 2019

(54) TEXTURE SPRAYER

(71) Applicant: TTI (MACAO COMMERCIAL OFFSHORE) LIMITED, Macau (MO)

(72) Inventors: Clinton C. Thackery, Clemson, SC (US); Jacob F. Creasman, Anderson, SC (US); John D. Schaalje, Williamson, SC (US); Graham M. Schaafsma, Raleigh, NC (US)

(21) Appl. No.: 16/381,223

(22) Filed: Apr. 11, 2019

Related U.S. Application Data
(60) Provisional application No. 62/657,165, filed on Apr. 13, 2018.

(51) Int. Cl. B05B 7/14; B05B 7/02; B05B 7/24

(52) U.S. Cl. CPC B05B 7/1404; B05B 7/2418; B05B 7/025

(57) ABSTRACT

A texture sprayer includes a main body and an inlet coupled to the main body. The inlet is configured to receive compressed air. A mixing chamber is disposed downstream of the inlet. The mixing chamber is configured to combine the compressed air with texture material to form a texture spray. A nozzle holder is coupled to the main body. The nozzle holder is movable between a first position and a second position. A first nozzle is coupled to the nozzle holder and a second nozzle is coupled to the nozzle holder. The texture sprayer is configured to discharge the texture spray along a spray axis through the first nozzle when the nozzle holder is in the first position and to discharge the texture spray along the spray axis through the second nozzle when the nozzle holder is in the second position.

### CROSS REFERENCE TO RELATED APPLICATIONS

This application claims priority to U.S. Provisional Patent Application No. 62/657,165, filed Apr. 13, 2018, the entire content of which is incorporated herein by reference.

### FIELD OF THE DISCLOSURE

The present disclosure relates to sprayers, and more particularly to texture sprayers usable to apply a texture coating to ceilings, walls, and the like.

### BACKGROUND OF THE DISCLOSURE

Texture sprayers typically include a spray gun that can be coupled to a source of compressed air. A material hopper feeds texture material into the spray gun, where the material is entrained in a stream of compressed air and expelled from the gun through a nozzle.

### SUMMARY OF THE DISCLOSURE

The present disclosure provides, in one aspect, a texture sprayer including a main body and an inlet coupled to the main body. The inlet is configured to receive compressed air. A mixing chamber is disposed downstream of the inlet. The mixing chamber is configured to combine the compressed air with texture material to form a texture spray. The texture sprayer also includes a nozzle holder coupled to the main body. The nozzle holder is movable between a first position and a second position. A first nozzle is coupled to the nozzle holder, and a second nozzle is coupled to the nozzle holder. The texture sprayer is configured to discharge the texture spray along a spray axis through the first nozzle when the nozzle holder is in the first position. The texture sprayer is configured to discharge the texture spray along the spray axis through the second nozzle when the nozzle holder is in the second position.

The present disclosure provides, in another aspect, a texture sprayer including a main body, an inlet coupled to the main body, the inlet being configured to receive compressed air, a nozzle holder rotatably coupled to the main body, and a plurality of nozzles coupled to the nozzle holder. The nozzle holder is rotatable between a plurality of positions, each position placing a different one of the plurality of nozzles in fluid communication with the inlet.

In another embodiment, a texture sprayer is disclosed. The texture sprayer includes a main body, an inlet coupled to the main body and configured to receive compressed air, an internal pathway disposed in the main body, the internal pathway being in fluid connection with the inlet, a hopper configured to supply texture material to the internal pathway, and a tilting mechanism that couples the hopper to the main body such that the hopper is pivotable relative to the main body. relative to the feed neck.

Other features and aspects of the disclosure will become apparent by consideration of the following detailed description and accompanying drawings.

### BRIEF DESCRIPTION OF THE DRAWINGS

FIG. 1 is a side view of a texture sprayer according to one embodiment of the disclosure.

FIG. 2 is a perspective view of a portion of a spray gun of the texture sprayer of FIG. 1.

FIG. 3 is a cross-sectional view illustrating the spray gun of FIG. 2 in an unactuated position.

FIG. 4 is a cross-sectional view illustrating the spray gun of FIG. 2 in an actuated position.

FIG. 5 is a front perspective view of the texture sprayer of FIG. 1.

FIG. 6 is a perspective view of the texture sprayer of FIG. 1 illustrating a hopper of the texture sprayer in an adjusted position.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

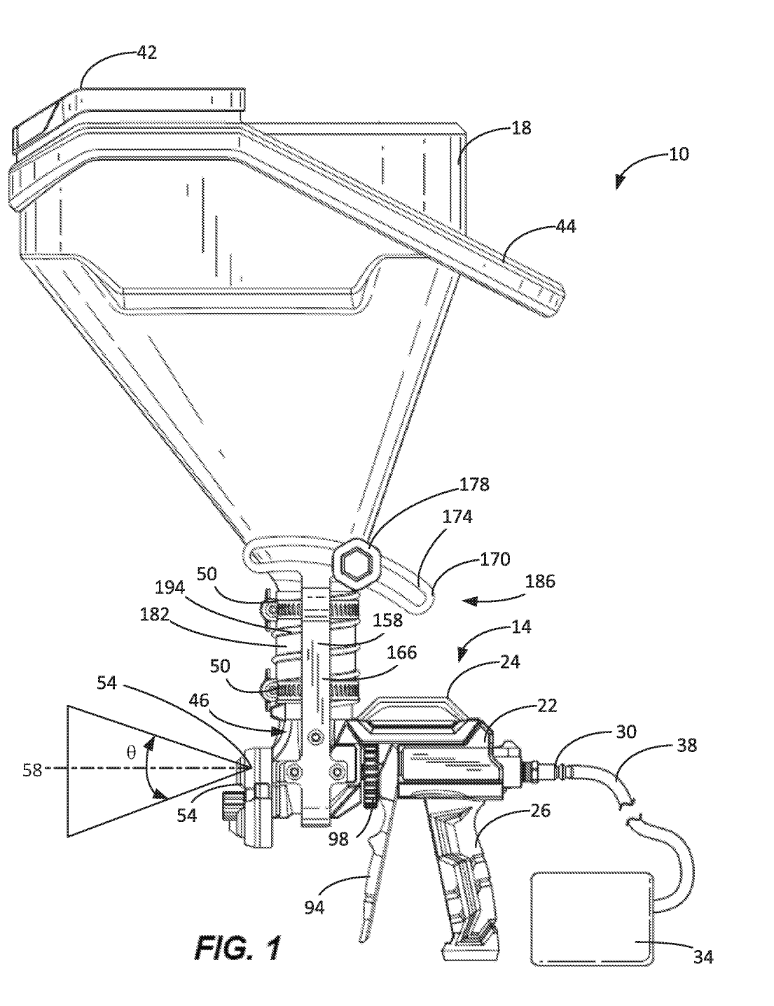

FIG. 1 illustrates a texture sprayer 10 according to one embodiment. The texture sprayer 10 may include a spray gun 14 and a hopper 18 coupled to the spray gun 14. In this way, as described here, the hopper 18 is portable so that the hopper 18 may travel with the spray gun 14 as a user sprays a large surface area. The spray gun 14 may have a main body 22 and a pistol grip or handle 26 extending from the main body 22. The spray gun 14 may further include a support structure or a bracket 24 extending from a top portion of the main body 22. The support structure 24 may be grasped during transportation or operation of the texture sprayer 10. Additionally, in some embodiments, a harness or lanyard may be connected to the support structure 24 for additional support use during use of the texture sprayer 10. The support structure 24 may be made from a different material than the main body 22 in some embodiments. For example, the support structure 24 may be made of metal for higher strength, and the main body 22 may be made of plastic for lower weight and cost.

In the illustrated embodiment, the spray gun 14 includes an inlet 30 extending rearward from the main body 22 that may be connected to an external source of compressed air 34 (e.g., an air compressor) via an air hose 38. Alternatively, the spray gun 14 may include an inlet at the base of the pistol grip 26, at other locations on the spray gun 14, or an internal inlet that receives air from an internal source of compressed air, such as a pressurized air cartridge, a battery-operated internal compressor, a combustible fuel cartridge, and/or the like.

The hopper 18 may receive and hold a volume of texture material to be applied to a surface (e.g., a wall, ceiling, or the like) during operation of the texture sprayer 10. The texture material may include wall texture compound, sand, joint compound, or any other desired material, optionally mixed with water, paint, or any other fluid. The hopper 18 may have an opening (not shown) in its top side for adding the texture material into the hopper 18. A lid 42 may cover the opening and may be removed or opened to provide access to the opening. The illustrated hopper 18 has a tapered or funnel shape that may feed the texture material, under the influence of gravity, toward a feed neck 46 of the spray gun 14. The hopper 18 may additionally include a handle 44, which may be disposed at an angle respective to the lid 42. In this way, the hopper 18 and/or the texture sprayer 10 may be more easily maneuvered, gripped, and/or handled when in use.

The feed neck 46 may have a generally cylindrical shape, and the hopper 18 may be removably coupled to the feed neck 46 by at least one clamp 50, such as a hose or band clamp. In other embodiments, the feed neck 46 may have other shapes, and the hopper 18 and feed neck 46 may be coupled together in a variety of different ways, such as via a friction fit or a clamping mechanism integrated into the feed neck 46. When connected, the hopper 18 and the feed neck 46 may collectively move respective to an axis, for example, by way of tilting or pivoting respective to the axis (e.g., pivot axis 190), as described further herein. In this way, the hopper 18 may articulate relative to the spray gun 14, which may improve the ease of adding material to the hopper 18 and/or improve the ease of handling the texture sprayer 10 during spraying operations.

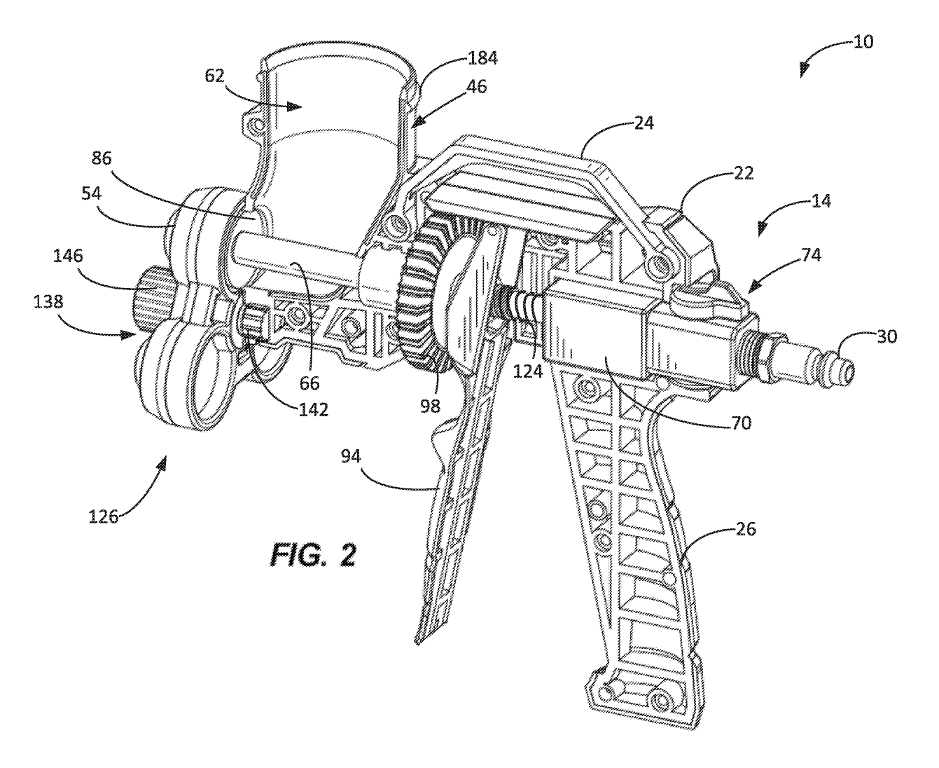

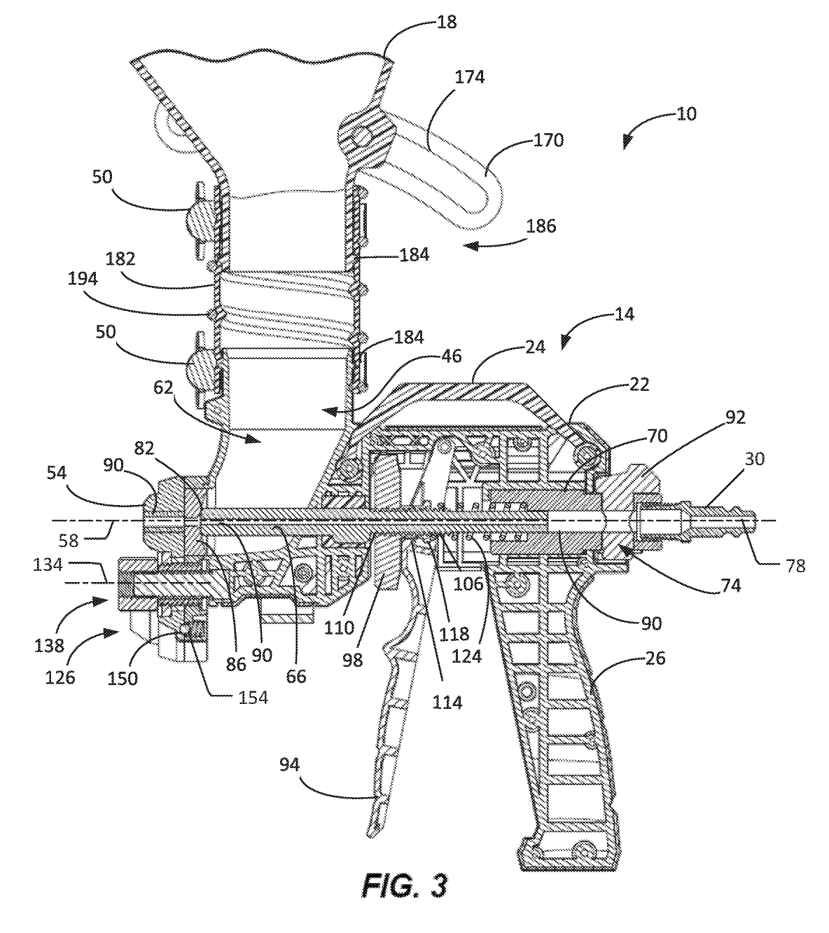

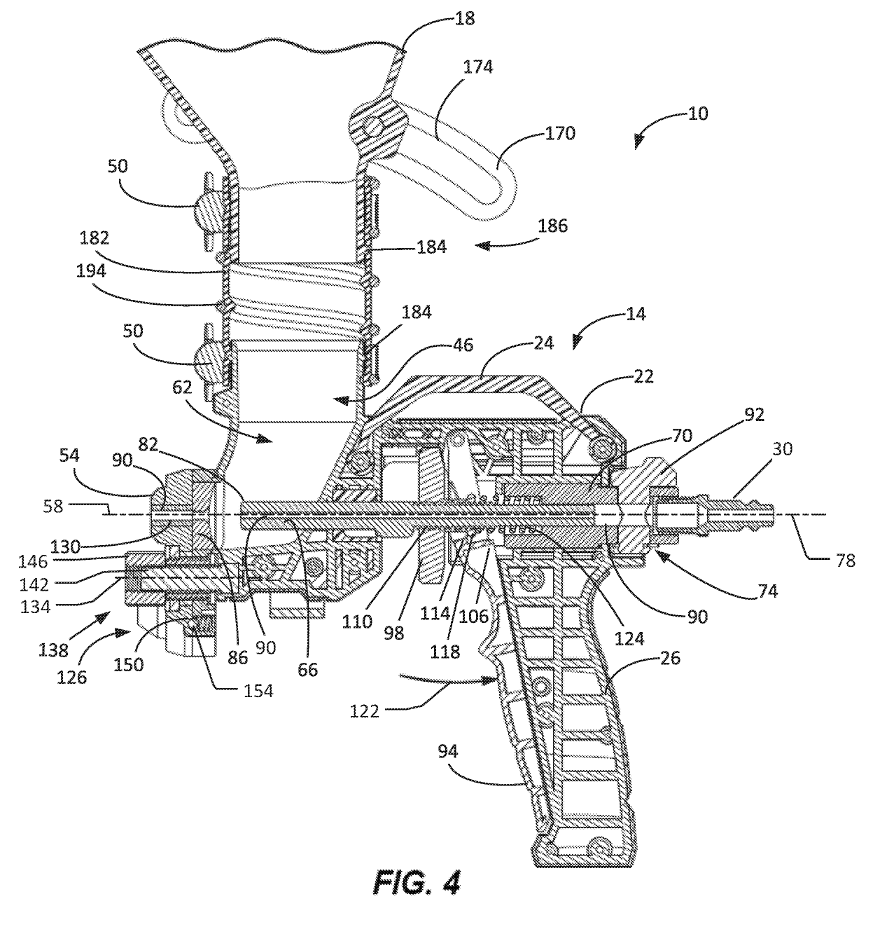

With reference to FIGS. 2-4, the illustrated spray gun 14 includes a nozzle 54 that defines a spray axis 58 (i.e., a central axis along which air or a mixture of air and texture material may be discharged from the spray gun 14). The spray gun 14 may also include a mixing chamber 62, a plunger 66 slidably received within a bushing 70 (FIGS. 3-4), and a valve assembly 74 disposed fluidly between the nozzle 54 and the inlet 30.

The plunger 66 may be movable along a longitudinal axis or a plunger axis 78 that may extend centrally through the plunger 66. In the illustrated embodiment, the plunger axis 78 is coaxial with the spray axis 58, but the plunger axis 78 may be offset from the spray axis 58 and/or non-coaxial respective to the spray axis 58 in other embodiments. The plunger 66 may be movable along the plunger axis 78 between an initial or unactuated position (FIG. 3) in which a distal end 82 of the plunger 66 is in contact with or engaged with a stopper 86 at a front end of the mixing chamber 62, and an actuated position (FIG. 4) in which the distal end 82 of the plunger 66 is spaced a distance apart from the stopper 86.

The plunger 66, the stopper 86, and the bushing 70 may each include a respective channel portion 90. The channel portions 90 may collectively align for defining an internal pathway that fluidly connects the inlet 30 to the nozzle 54 when a valve element 92 of the valve assembly 74 is in an open position, as illustrated in FIGS. 3 and 4. In the illustrated embodiment, the spray gun 14 may operate as a “bleeder” spray gun 14 when the valve element 92 of the valve assembly 74 is in the open position. That is, when the source of compressed air 34 is connected to the inlet 30 and the valve element 92 of the valve assembly 74 is open, pressurized air may be continuously fed through the internal pathway and out of the nozzle 54, regardless of the position of the plunger 66. The valve element 92 of the valve assembly 74 may be actuated to a closed position (not shown) to prevent air from flowing from the inlet 30 to the plunger 66 and the nozzle 54. In the illustrated embodiment, the valve assembly 74 is configured as a banjo valve with the valve element 92 being rotatable about an axis transverse to the plunger axis 78 and the spray axis 58 to open and close the valve assembly 74. Other types of valves and/or valve assemblies are contemplated, and may be used in some embodiments. Alternatively, the valve assembly 74 may be omitted.

With continued reference to FIGS. 3-4, the spray gun 14 may further include an actuator lever 94 or trigger pivotally coupled to the main body 22 and an actuator control mechanism 98 coupled to an external portion of the plunger 66. The actuator lever 94 may include a comfortable gripping material and an exterior shape configured to reduce operator fatigue during use of the texture sprayer 10. The exterior of the plunger 66 may include external threads 106, and the actuator control mechanism 98 may include internal threads 110 configured to engage the external threads 106 of the plunger 66. The actuator lever 94 may include a ledge 114 that is engageable with an annular wall 118 of the actuator control mechanism 98 surrounding the plunger 66. More specifically, the actuator lever 94 may be pivoted relative to the main body 22 in an actuating direction 122, causing the ledge 114 to bear against the annular wall 118 to move the plunger 66 and the actuator control mechanism 98 together rearward along the plunger axis 78 toward the actuated position (FIG. 4).

A biasing member 124 may surround the plunger 66 and be positioned between the annular wall 118 and the bushing 70. The biasing member 124 may bias the actuator lever 94 towards the unactuated position. In the illustrated embodiment, the biasing member 124 is a compression spring. In other embodiments, other types of biasing member may be used (e.g., a torsion spring, magnets, or the like), and the biasing member may be positioned in different positions or orientations to bias the actuator lever 94 to the unactuated position.

The actuator control mechanism 98 may be shaped as a user-manipulable dial and may be rotated about the plunger axis 78 to adjust an axial position of the actuator control mechanism 98 due to the threaded engagement between the actuator control mechanism 98 and the plunger 66. This, in turn, may adjust a position of the actuator lever 94 relative to the plunger 66 and therefore vary a total amount of travel required for the actuator lever 94 to move the plunger 66 to the actuated position. In other embodiments, the actuator control mechanism 98 may include a locking pin or any other mechanism configured to hold the actuator lever 94 in a desired position. In some embodiments, the actuator lever 94 may be operatively coupled to the valve assembly 74 such that movement of the actuator lever 94 may open and/or close the valve assembly 74 to allow compressed air to respectively flow and/or stop flowing into the internal pathway.

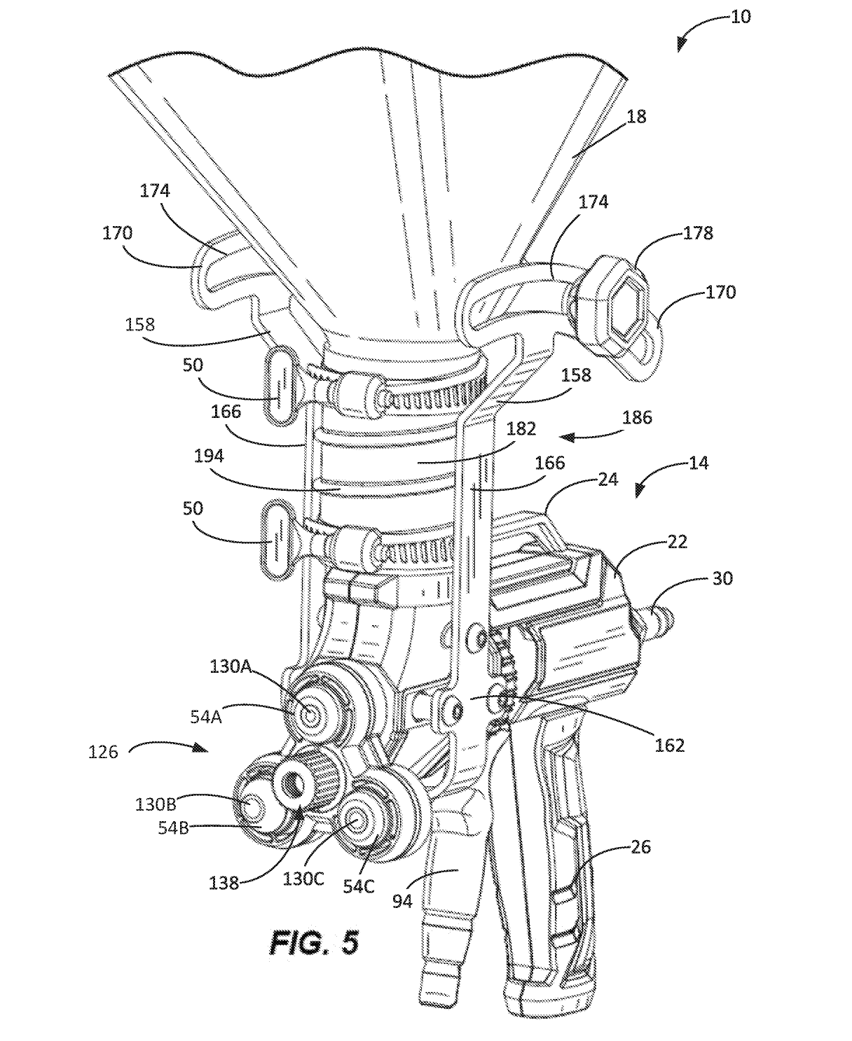

With reference to FIG. 5, the nozzle 54 may include a first nozzle 54A of a plurality of nozzles (54A, 54B, and 54C) coupled to a nozzle holder 126 at the front end of the spray gun 14. The illustrated nozzle holder 126 is configured to accommodate at least two or more nozzles, and in some cases, three or more nozzles (see, e.g., nozzles 54A to 45C). Each nozzle 54A-54C may have a differently sized and/or shape orifice for providing different spray characteristics of the texture material through the nozzle 54. For example, the first nozzle 54A may have a first orifice 130A with a first diameter, the second nozzle 54B may have a second orifice 130B with a second diameter that is different than the first diameter, and the third nozzle 54C may have a third orifice 130C with a third diameter that is different than the first diameter and the second diameter. As used herein, the word “different” means having appreciable differences beyond minor variations that may occur as a result of manufacturing tolerances. Additionally, in some cases, the orifices 130A-130C may differ in regard to characteristics other than diameter, for example, the orifices 130A-130C may differ in regard to shape (e.g., planar shape, sectional shape, and/or the like), direction or angle (e.g., for spraying in different directions), quantity (e.g., 130A may be comprised of a group of multiple, small orifices), and/or the like.

In the illustrated embodiment, the nozzle holder 126 is rotatably coupled to the main body 22 of the spray gun 14. In the illustrated embodiment, the nozzle holder 126 has a tri-lobe shape and is rotatable about a center axis 134 (FIGS. 3 and 4) of the nozzle holder 126. In some embodiments, the center axis 134 may be parallel to the spray axis 58. As such, the nozzle holder 126 may be rotated to align a selected one of the nozzles 54A-54C with the spray axis 58 for use. In this way, each nozzle 54A-54C, when coupled to the nozzle holder 126 and aligned with the spray axis 58, may provide the texture sprayer 10 with a different spray characteristic, such as a different flow rate, flow velocity, spread angle θ, and/or spray pattern. In other embodiments, the nozzle holder 126 may include any number of nozzles (e.g., two, three, or four nozzles, etc.) to allow the user to select and implement one of several different spray characteristics.

In some embodiments, the nozzles 54A-54C may be removably coupled to the nozzle holder 126 and interchangeable with other nozzles. For example, individual nozzles may be removed from the nozzle holder 126 and replaced if they become clogged, or if other spray characteristics are desired. In some embodiments, each of the nozzles 54A-54C may be threadably coupled to the nozzle holder 126. In other embodiments, the nozzles 54A-54C may be coupled to the nozzle holder 126 in other ways that provide a fluid tight seal. In some embodiments, the texture sprayer 10 may include a spare nozzle carrier (not shown) including a plurality of recesses configured to securely receive and store extra interchangeable nozzles. In some embodiments, the spare nozzle carrier may be coupled to or integrally formed with the hopper 18.

The nozzle holder 126 may be secured to the spray gun 14 via an adjustment mechanism 138 positioned along the center axis 134 of the nozzle holder 126. The adjustment mechanism 138 may allow the nozzle holder 126 to be selectively rotated between a plurality of positions to align a selected one of the nozzles 54A-54C with the spray axis 58. In the illustrated embodiment, the adjustment mechanism 138 includes a bolt 142 that extends through the nozzle holder 126 and a nut 146 positioned on the front side of the nozzle holder 126 in threaded engagement with the bolt 142. (FIGS. 3-4). In other embodiments, the adjustment mechanism 138 may be spring loaded or have any other construction that is configured to allow the nozzle holder 126 to selectively rotate about the center axis 134.

Rotation of the nut 146 about the center axis 134 in a loosening direction may loosen the nozzle holder 126 and allow rotation of the nozzle holder 126 about the central axis 134 between a plurality of positions. For example, the nozzle holder 126 may be rotated between a first position in which the first nozzle 54A aligned with the spray axis 58, a second position in which the second nozzle 54B is aligned with the spray axis 58, and a third position in which the third nozzle 54C is aligned with the spray axis 58. In some embodiments, the nut 146 may be completely removed from the bolt 142 to allow the nozzle holder 126 to be removed and replaced with a replacement nozzle holder. In this way, the efficiency at which clogged and/or damaged nozzles may be interchanged may improve.

In the illustrated embodiment, the adjustment mechanism 138 further includes a plurality of recesses 150 (see, e.g., FIGS. 3-4) formed on a rear side of the nozzle holder 126 that are each engageable with a spring-biased detent 154 on the main body 22 of the spray gun 14 to retain the nozzle holder 126 in one of a plurality of predetermined positions. That is, the detent 154 may engage one of the recesses 150 to more securely retain the nozzle holder 126 in the first position, the second position, and/or the third position, respectively. In other embodiments, a plurality of detents may be provided on the nozzle holder 126, and a recess may be provided on the main body 22 of the spray gun 14. The detents and recesses may also be engageable to provide a tactile or audible indication to a user to indicate when a particular nozzle 54 is set in the proper position.

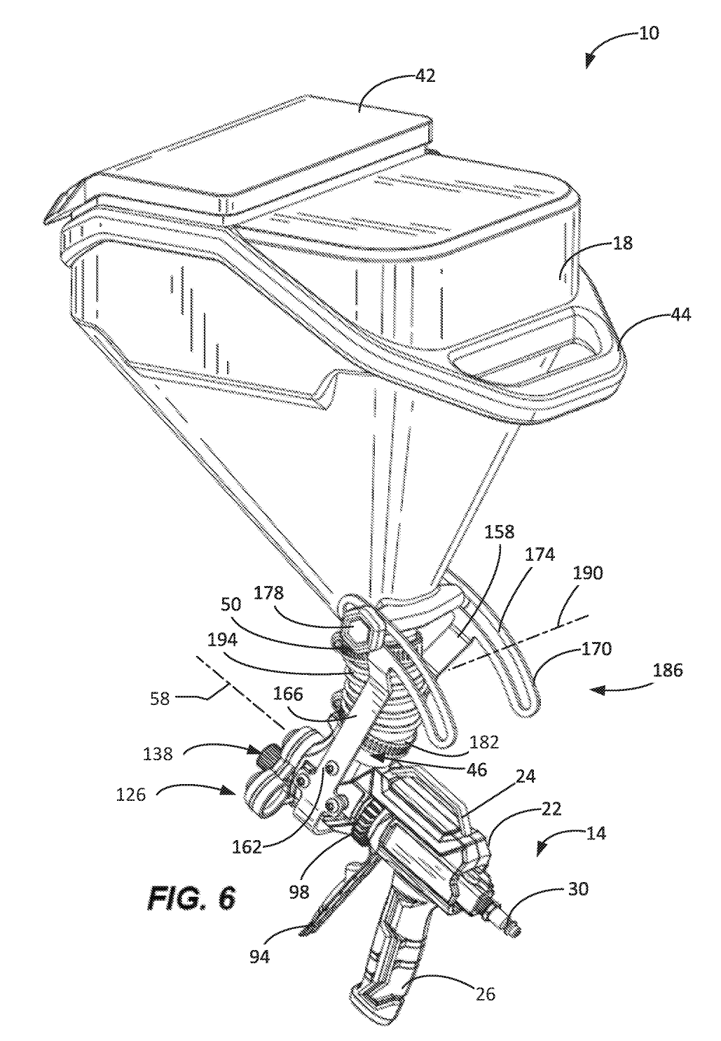

With reference to FIGS. 5 and 6 the texture sprayer 10 may further include a pair of guide brackets 158 coupled to the main body 22 of the spray gun 14 on either side of the feed neck 46. Each of the guide brackets 158 may include an attachment portion 162 secured (e.g., mounted, fixed, and/or the like) to the main body 22 of the spray gun 14 (e.g., via welding, use of a plurality of fasteners, and/or the like), an extension 166 extending upward from the attachment portion 162, and a guide track 170 disposed at an end of the extension 166 opposite the attachment portion 162. In some embodiments, the guide track 170 may be an arcuate guide track 170 that includes a slot 174 configured to receive a projection or fastener 178 extending from a lateral side of the hopper 18.

The hopper 18 may be coupled to the feed neck 46 by a flexible coupling 182. The feed neck 46 and the hopper 18 may include integral annular projections or beads 184 (FIGS. 3 and 4). The beads 184 may provide a fluid tight connection between the hopper 18, the flexible coupling 182, and the feed neck 46. The flexible coupling 182, together with the guide brackets 158 and fastener 178, defines a moving or tilting mechanism 186 of the texture sprayer 10. As illustrated in FIG. 6, the tilting mechanism 186 may allow the hopper 18 to move, tilt, and/or pivot relative to the spray gun 14 about a pivot axis 190 that is generally perpendicular to the spray axis 58. The flexible coupling 182 may include a pivotable coupling, such as an elastomeric coupling, a spring coupling, or any other structure or type of coupling that permits the hopper 18 to move relative to the spray gun 14 while the flexible coupling 182 remains attached to the feed neck 46 and the hopper 18. In the illustrated embodiment, the flexible coupling 182 may include a biasing member 194, such as a coil spring integrated with the flexible coupling 182. The biasing member 194 is configured to bias the hopper 18 toward a vertical position (shown in FIGS. 1 and 2-5) in which the hopper 18 is perpendicular, or substantially perpendicular (i.e., within +/−10 degrees of being perpendicular), to the spray axis 58. As such, if the hopper 18 is secured in an oblique orientation relative to the spray axis 58, the hopper 18 may return to the vertical position when the fastener 178 is loosened. In some embodiments, the flexible coupling 182 may be an accordion-style coupling. In this way, the hopper 18 may be biased in a direction or orientation that prevents the loss or spillage of material being contained by the hopper 18.

In operation, the hopper 18 may be filled with a desired texture material, and the compressed air source 34 may be coupled to the inlet 30 of the spray gun 14 (FIG. 1). The valve assembly 74 may be opened, which may allow compressed air to continuously flow from the inlet 30 to a selected nozzle 54 through the internal pathway defined by the respective channel portions 90 (FIG. 3). The actuator lever 94 may be moved in the actuating direction 122 to begin spraying (e.g., expelling) the texture material from the spray gun 14 (FIG. 4). In particular, the ledge 114 of the actuator lever 94 may engage with the annular wall 118 of the actuator control mechanism 98, which translates with the plunger 66 along the plunger axis 78 toward the actuated position.

The texture material may be fed from the hopper 18 into the mixing chamber 62 and/or the internal pathway under the influence of gravity. With the plunger 66 in the actuated position, the distal end 82 of the plunger 66 is spaced from the stopper 86 to provide a gap for the texture material in the mixing chamber 62 to mix with the air flowing through the plunger 66. The texture material is entrained in the air stream, and the resulting mixture is forcefully discharged through the selected nozzle 54A-54C to form a texture spray. In some embodiments, the actuator control mechanism 98 may be rotated to hold the actuator lever 94 in the desired position, or to change the amount of travel or “feel” of the actuator lever 94 to initiate a spraying operation.

The spray characteristic of the texture sprayer 10 may be changed by rotating the nut 146 of the adjustment mechanism 138 about the center axis 134 to loosen the nozzle holder 126. Once loosened, the nozzle holder 126 may then be rotated about the center axis 134 to align a selected nozzle 54A-54C with the spray axis 58.

During operation, it may be desirable to tilt the spray gun 14 up or down (e.g. to vary an angle of inclination of the spray axis 58 relative to the horizon) to target particular areas of a surface being sprayed. The tilting mechanism 186 allows the hopper 18 to remain in a generally vertical orientation as the spray gun 14 is tilted, to an extent limited by the ends of the guide tracks 170 (FIG. 6). This advantageously facilitates consistent feeding of the texture material from the hopper 18 into the mixing chamber 62, and inhibits spilling the texture material out of the hopper 18. In particular, as the spray gun 14 is tilted up or down, the hopper 18 may be reoriented relative to the main body 22 by pushing or pulling on the hopper 18. In response, the flexible coupling 182 may deform to allow movement of the remainder of the hopper 18 relative to the main body 22 of the spray gun 14. Movement of the hopper 18 may be constrained by the engagement between the fasteners 178 and the slots 174 in the guide tracks 170. As such, movement of the hopper 18 may be limited to pivotal movement about the pivot axis 190.

As the user loosens the fasteners 178, the biasing member 194 may urge the movement of the hopper 18 toward a vertical position. This may prevent the hopper 18 from moving suddenly under the influence of gravity when the fasteners 178 are loosened. In some embodiments, the biasing member 194 may also be sufficiently strong to restore the hopper 18 to its vertical orientation (relative to the feed neck) without the application of any other external force(s).

Various features of the present subject matter are set forth in the following claims.

1. A texture sprayer comprising:
a main body;
an inlet coupled to the main body,
the inlet being configured to receive compressed air;
a mixing chamber disposed downstream of the inlet,
the mixing chamber being configured to combine the compressed air with texture material to form a texture spray;
a nozzle holder coupled to the main body,
the nozzle holder being movable between a first position and a second position;
a first nozzle coupled to the nozzle holder; and
a second nozzle coupled to the nozzle holder,
wherein the texture sprayer is configured to discharge the texture spray along a spray axis through the first nozzle when the nozzle holder is in the first position, and
wherein the texture sprayer is configured to discharge the texture spray along the spray axis through the second nozzle when the nozzle holder is in the second position.

2. The texture sprayer of claim 1, wherein the second nozzle is offset from the spray axis when the nozzle holder is in the first position.

3. The texture sprayer of claim 1, wherein:
the nozzle holder is movable to a third position,
the texture sprayer includes a third nozzle coupled to the nozzle holder, and
the texture sprayer is configured to discharge the texture spray along the spray axis through the third nozzle when the nozzle holder is in the third position.

4. The texture sprayer of claim 1, wherein the nozzle holder is rotatably coupled to the main body.

5. The texture sprayer of claim 4, wherein the nozzle holder is rotatable about a center axis of the nozzle holder that is offset from the spray axis.

6. The texture sprayer of claim 4, wherein the nozzle holder includes an adjustment mechanism configured to selectively secure the nozzle holder in the first position or the second position.

7. The texture sprayer of claim 1, further comprising:
a feed neck extending from the mixing chamber;
a hopper configured to feed the texture material into the mixing chamber through the feed neck; and
a tilting mechanism that couples the hopper to the feed neck such that the hopper is pivotable relative to the main body about a pivot axis.

8. The texture sprayer of claim 7, wherein the tilting mechanism includes:
a flexible coupling extending between the hopper and the feed neck, and
a guide bracket coupled to the main body,
wherein the guide bracket includes an arcuate guide track configured to receive a projection extending from a side of the hopper.

9. A texture sprayer comprising:
a main body;
an inlet coupled to the main body and configured to receive compressed air;
a nozzle holder rotatably coupled to the main body; and
a plurality of nozzles coupled to the nozzle holder,
wherein the nozzle holder is rotatable between a plurality of positions, each position placing a different one of the plurality of nozzles in fluid communication with the inlet.

10. The texture sprayer of claim 9, wherein the plurality of nozzles includes a first nozzle, a second nozzle, and a third nozzle.

11. The texture sprayer of claim 10, wherein the nozzle holder has a tri-lobe shape.

12. The texture sprayer of claim 9, wherein the nozzle holder is rotatable about a central axis that is parallel to a spray axis of each of the plurality of nozzles.

13. The texture sprayer of claim 9, further comprising:
a mixing chamber downstream of the inlet;
a feed neck extending from the mixing chamber; and
a hopper coupled to the feed neck and configured to supply texture material into the mixing chamber through the feed neck.

14. The texture sprayer of claim 13, further comprising:
a tilting mechanism that couples the hopper to the feed neck such that the hopper is pivotable relative to the feed neck,
wherein the tilting mechanism includes a biasing member configured to bias the hopper toward a vertical position.

15. A texture sprayer comprising:
a main body;
an inlet coupled to the main body and configured to receive compressed air;
an internal pathway disposed in the main body,
the internal pathway being in fluid connection with the inlet;
a hopper configured to supply texture material to the internal pathway; and
a tilting mechanism that couples the hopper to the main body such that the hopper is pivotable relative to the main body.

16. The texture sprayer of claim 15, wherein the internal pathway includes a mixing chamber downstream of the inlet and a feed neck extending from the mixing chamber.

17. The texture sprayer of claim 16, wherein the tilting mechanism includes a flexible coupling extending between the feed neck and the hopper, and a guide bracket coupled to the main body.

18. The texture sprayer of claim 17, wherein the guide bracket includes an arcuate guide track having a slot, wherein a projection extending from the hopper is received within the slot, and wherein engagement between the projection and the slot limits pivotal movement of the hopper relative to the main body.

19. The texture sprayer of claim 17, wherein the tilting mechanism includes a biasing member surrounding the flexible coupling, wherein the biasing member is configured to bias the hopper toward a vertical position.

20. The texture sprayer of claim 15, further comprising a plurality of nozzles, wherein each nozzle of the plurality of nozzles is selectively positionable in fluid communication with the inlet.

21. The texture sprayer of claim 15, further comprising a valve assembly downstream of the inlet.
